(19) United States
(12) Patent Application Publication
(10) Pub. No.: US 2007/0096706 A1
(43) Pub. Date: May 3, 2007

(54) Power supply control method and power supply apparatus

(75) Inventors: Kentaro Terakado, Ome-shi (JP); Shizuo Morioka, Hanno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/585,186

(22) Filed: Oct. 24, 2006

(30) Foreign Application Priority Data
Oct. 31, 2005 (JP) 2005-317694

(51) Int. Cl. G05F 1/00

(52) U.S. Cl. 323/282

(57) ABSTRACT

According to one embodiment, in this invention, a control method for a switching power supply using pulse width modulation (PWM) control, includes detecting an input voltage to be supplied to the switching power supply, detecting an output voltage from the switching power supply, calculating a timing for sampling a current for the PWM control, based on a ratio between the detected input voltage and the detected output voltage, and detecting the current based on the calculated timing.

### CROSS-REFERENCE TO RELATED APPLICATIONS

This application is based upon and claims the benefit of priority from Japanese Patent Application No. 2005-317694, filed Oct. 31, 2005, the entire contents of which are incorporated herein by reference.

### BACKGROUND

1. Field

One embodiment of the invention relates to a power supply control method and power supply apparatus using pulse width modulation (PWM) control.

2. Description of the Related Art

It is disclosed by, for example, Jpn. Pat. Appln. KOKAI Publication No. 11-289754 to improve the output accuracy of a switching power supply using PWM control. In recent years, various so-called digital power supply apparatuses are also developed, each of which PWM-controls a DC/DC converter by using a digital signal processor (DSP).

In order to obtain a desirable output voltage from an input voltage, the DC/DC converter of the switching power supply using PWM control has a feedback loop (control loop) for monitoring and controlling a voltage and current. However, the detected current accuracy for PWM control in the control loop influences the output accuracy, thus posing a problem.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram showing the structure of a power supply apparatus to which a power supply control method is applied according to a first embodiment of the invention;

FIG. 2 is a flowchart showing a processing procedure executed in a switching period (T) according to the first embodiment;

FIG. 3A is a chart showing the waveform of a current flowing through an inductor for explaining the operation according to the first embodiment;

FIG. 3B is a chart showing a PWM signal waveform for explaining an operation according to the first embodiment;

FIG. 4 is a chart showing a signal waveform of a PWM control mode according to the first embodiment; and

FIG. 5 is a chart showing a waveform obtained by enlarging a portion of the waveform shown in FIG. 4 according to the first embodiment.

### DETAILED DESCRIPTION

Various embodiments according to the invention will be described hereinafter with reference to the accompanying drawings. In general, according to one embodiment of the invention, there is provided a power supply control method for a switching power supply using pulse width modulation (PWM) control, comprising detecting an input voltage to be supplied to the switching power supply, detecting an output voltage from the switching power supply, calculating a timing for sampling a current for the PWM control, based on a ratio between the detected input voltage and the detected output voltage, and detecting the current based on the calculated timing.

According to another embodiment of the invention, there is provided a power supply apparatus comprising a first detection unit which detects an input voltage to be supplied to a switching power supply using PWM control, a second detection unit which detects an output voltage from the switching power supply, a calculation unit which calculates, based on a ratio between the input voltage detected by the first detection unit and the output voltage detected by the second detection unit, a timing for sampling a current for the PWM control, and a third detection unit which detects the current based on the calculated timing.

According to still another embodiment of the invention, there is provided a power supply apparatus comprising a DC/DC conversion unit which includes an inductor, and a switching element controlled in accordance with a PWM signal, a first detection unit which detects an input voltage to be supplied to the DC/DC conversion unit, a second detection unit which detects an output voltage from the DC/DC conversion unit, a calculation unit which calculates, based on a ratio between the input voltage detected by the first detection unit and the output voltage detected by the second detection unit, a timing for sampling a current flowing through the inductor, a third detection unit which detects, at the timing calculated by the calculation unit, the current flowing through the inductor, and a PWM control unit which controls, by using a value of the current detected by the third detection unit and a value of the output voltage detected by the third detection unit, a pulse width of a PWM signal to be supplied to the switching element.

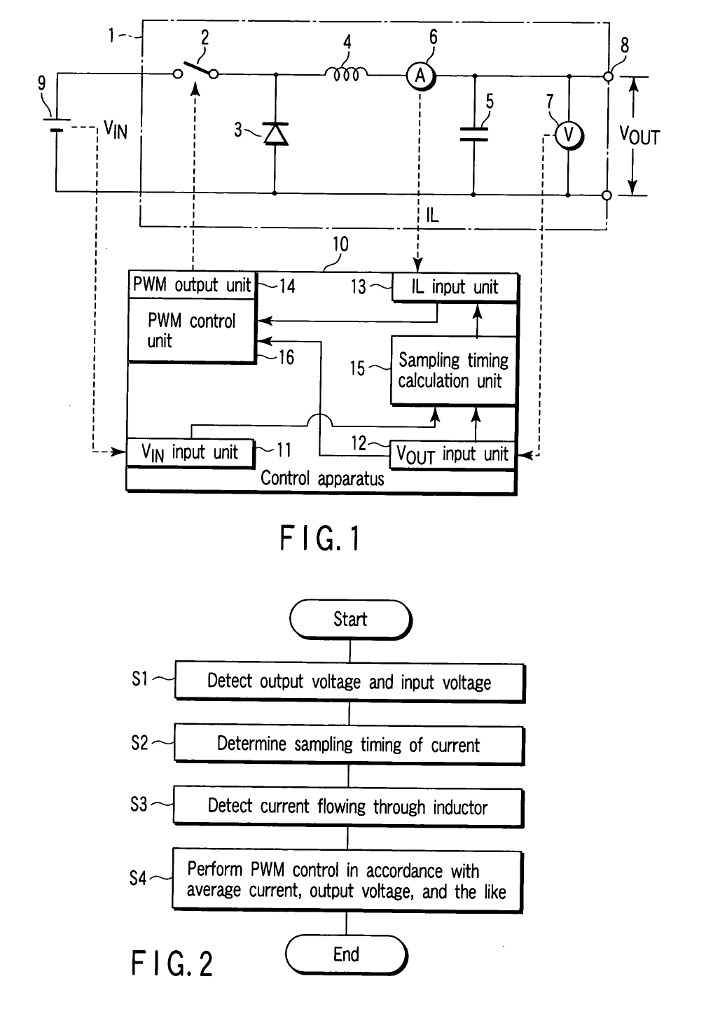

According to an embodiment, FIG. 1 shows the arrangement of a power supply apparatus to which a power supply control method is applied according to the first embodiment of the invention.

According to the first embodiment of the invention, the power supply apparatus to which the power supply control method is applied includes a DC/DC converter 1 and control apparatus 10. The DC/DC converter 1 implements a switching power supply. The DC/DC converter 1 includes a switching element 2 (using, e.g., a switching FET), rectifier 3, smoothing inductor 4, and capacitor 5.

The DC/DC converter 1 also includes a current detection unit 6, voltage detection unit 7, and output voltage terminal 8. The current detection unit 6 detects a current (IL) flowing through the inductor 4 in the DC/DC converter 1. The voltage detection unit 7 detects an output voltage (V_{OUT}) of the DC/DC converter 1. Additionally, a main power supply 9 is connected as an input power supply to the DC/DC converter 1.

The control apparatus 10 serves as a DSP, and has a PWM control function. The control apparatus 10 includes a V_{IN} input unit 11, V_{OUT} input unit 12, IL input unit 13, PWM output unit 14, sampling timing calculation unit 15, PWM control unit 16, and the like.

The V_{IN} input unit 11 analog-to-digital-converts l ) the input voltage (V_{IN}) from the main power supply 9, and inputs the converted input voltage. That is, the V_{IN} input unit 11 functions as a detection unit for detecting the input voltage (V_{IN}) from the main power supply 9. The V_{OUT} input unit 12 analog-to-digital-converts the output voltage (V_{OUT}) detected by the voltage detection unit 7, and inputs the converted output voltage.

The IL input unit 13 analog-to-digital-converts, based on a sampling timing calculated by the sampling timing calculation unit 15, the current (IL) which flows through the inductor 4 and is detected by the current detection unit 6. Then, the IL input unit 13 inputs an average current (IL_Avg).

The PWM output unit 14 digital-to-analog-converts the PWM signal for performing switching control of the switching element 2, and outputs the converted PWM signal.

The sampling timing calculation unit 15 calculates, based on the ratio between the input voltage (V_{IN}) and the output voltage (V_{OUT}), the sampling timing for analog-to-digital-converting the current (IL) flowing through the inductor 4 to input the average current (IL_Avg) to the IL input unit 13.

In accordance with, e.g., the average current (IL_Avg), the output voltage (V_{OUT}), and a reference voltage (not shown), the PWM control unit 16 outputs the PWM signal whose pulse width (ON period) is controlled. The average current (IL_Avg) is obtained by analog-to-digital-converting the current based on the sampling timing calculated by the sampling timing calculation unit 15.

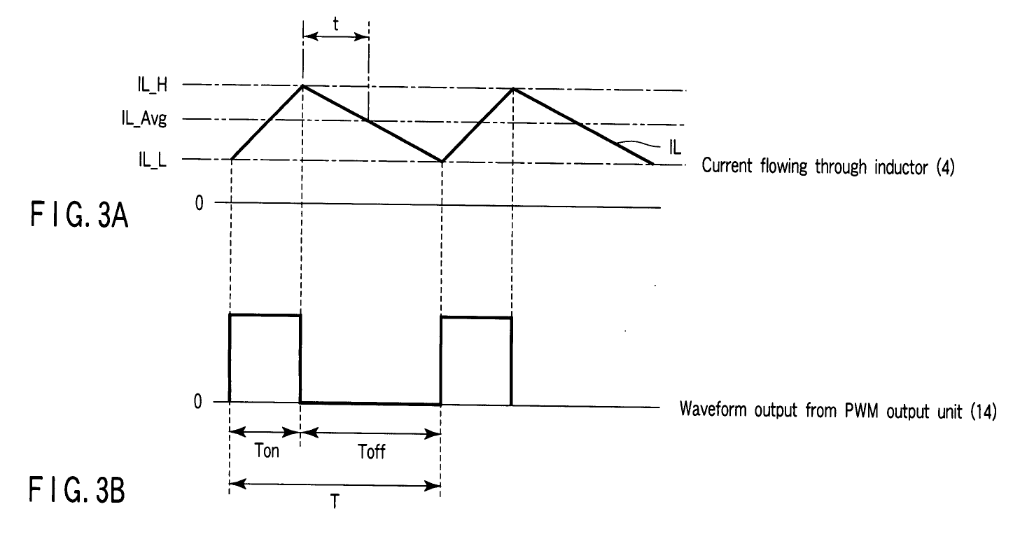

FIG. 2 shows a processing procedure executed in a switching period (T) in the control apparatus 10. In this processing, the sampling timing calculation unit 15 detects the input voltage (V_{IN}) from the V_{IN} input unit 11, and the output voltage (V_{OUT}) from the V_{OUT} input unit 12 (step S1). Based on the ratio between the input voltage V_{IN} and the output voltage V_{OUT}, the sampling timing calculation unit 15 calculates the sampling timing of the current (IL) flowing through the inductor 4 (step S2). A sampling timing calculation process in the sampling timing calculation unit 15 will be described later with reference to FIGS. 3 to 5.

The IL input unit 13 analog-to-digital-converts the current (IL) which flows through the inductor 4 and is detected by the current detection unit 6, based on the sampling timing (detection timing) calculated (determined) by the sampling timing calculation unit 15. Then, the IL input unit 13 inputs the converted current (step S3).

The PWM control unit 16 controls the pulse width (ON period) of the PWM signal in accordance with the average current (IL_Avg) output from the IL input unit 13, the output voltage (V_{OUT}), the reference voltage (not shown), and the like. The PWM control unit 16 then outputs the controlled PWM signal to the PWM output unit 14 (step S4).

The PWM output unit 14 digital-to-analog-converts the PWM signal output from the PWM control unit 16, and outputs the converted PWM signal to the DC/DC converter 1. The switching element 2 of the DC/DC converter 1 executes switching control in accordance with the PWM signal output from the PWM output unit 14, and then executes power supply output control in accordance with the ON duty of the PWM signal.

The sampling timing calculation process in the sampling timing calculation unit 15 will be described with reference to FIGS. 3 to 5.

The ON duty (D) of the PWM signal output from the PWM output unit 14 can be approximately given by the ratio between the input voltage (V_{IN}) and the output voltage (V_{OUT}) as follows, or by the ratio between the switching period (T) and the ON period (Tₒₙ):

$$\begin{matrix}D = ( output voltage ) \div ( input voltage ) \\ = ( ON period ) \div ( switching period )\end{matrix} \qquad ( 1 )$$

FIG. 3A shows the waveform of the current (IL) flowing through the inductor 4, and FIG. 3B shows the waveform of the PWM signal output from the PWM output unit 14.

In the ON period (Tₒₙ) of the PWM signal output from the PWM output unit 14, the current flowing through the inductor 4 increases to the maximum amplitude value (IL_H).

In the OFF period (T_{off}) of the PWM signal output from the PWM output unit 14, the current flowing through the inductor 4 decreases to the minimum amplitude value (IL_L).

Accordingly, the average current [IL_Avg] is given by:
IL_Avg=(IL_H+IL_L)÷2 (2)

A timing t when the current flowing through the inductor 4 decreases to the average value (IL_Avg) in the OFF period (T_{off}) is given by:

$$\begin{matrix}t = ( T + {T}_{on} ) \div 2 \\ = ( T \div 2 ) \times \{ 1 + ( output voltage ) \div ( input voltage ) \}\end{matrix} \qquad ( 3 )$$

As described above, since the current flowing through the inductor 4 is supplied from the IL input unit 13 at the timing t, the control apparatus 10 always measures the average current [IL_Avg].

Thus, PWM control can be accurately performed by using average current mode control to accurately detect the average current [IL_Avg].

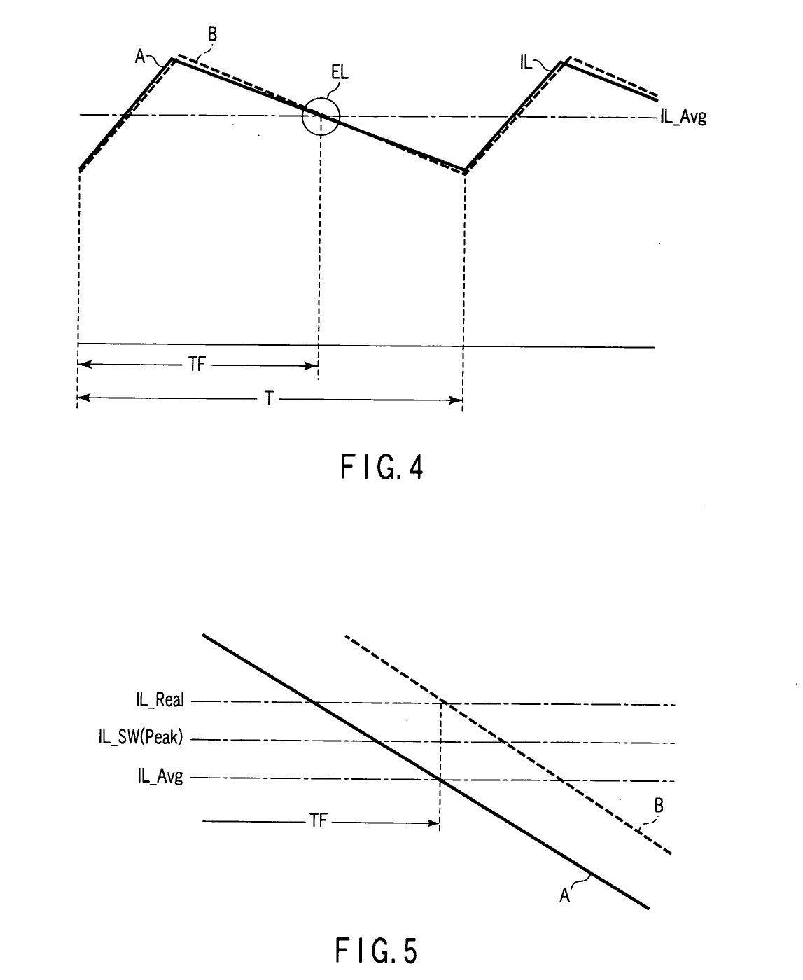

FIGS. 4 and 5 show the waveforms (inductor current waveforms) of the current (IL) flowing through the inductor 4 for PWM control. FIG. 5 shows the waveforms obtained by enlarging portions of the waveforms in an area EL shown in FIG. 4. In FIG. 4 or 5, a partial waveform A indicated by the solid line is a normal inductor current waveform, and a partial waveform B indicated by the dashed line is an inductor current waveform when the ON duty (D) changes. Reference symbol TF denotes a fixed sampling timing.

Generally, in this type of switching power supply, overvoltage protection (OVP), overcurrent protection (OCP), over-temperature protection (OTP), and the like are performed. A question is raised about overcurrent protection (OCP) of these operations.

When the average current (IL_Avg) exceeds a peak switch current (IL_SW (Peak)), the operation stops due to an overcurrent protection function. Assume that the sampling timing at which the average current (IL_Avg) is supplied to the IL input unit 13 is fixed (the fixed sampling timing TF), and that the normal inductor current waveform shown as the waveform A instantaneously changes to the inductor current waveform shown as the waveform B in changing the ON duty, and then returns to the waveform A immediately after that. In this case, the average current (IL_Avg) actually detected in changing the ON duty exceeds the peak switch current (IL_SW (Peak)), and the operation stops due to the overcurrent protection function. Hence, even if the current waveform returns to the normal inductor current waveform shown as the waveform A within a short period of time, and the average current (IL_Avg) decreases below the peak switch current (IL_SW (peak)), the operation may be kept stopped. To cope with this problem, the sampling timing is calculated based on the ratio between the input voltage and the output voltage. Accordingly, the average current can always be measured, and PWM control can be accurately performed by average current mode control.

As described above, in the power supply system for PWM control, the current flowing through the coil is controlled based on the ratio between the input voltage and the output voltage. Accordingly, the average current [IL_Avg] can always be measured, and PWM control can be stably performed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply control method for a switching power supply using pulse width modulation (PWM) control, comprising:
detecting an input voltage to be supplied to the switching power supply;
detecting an output voltage from the switching power supply;
calculating a timing for sampling a current for the PWM control, based on a ratio between the detected input voltage and the detected output voltage; and
detecting the current based on the calculated timing.

2. A method according to claim 1, wherein the detected current is a current flowing through an inductor arranged in a current path of a DC/DC converter included in the switching power supply.

3. A method according to claim 2, wherein calculating a timing for sampling comprises calculating, based on the ratio between the input voltage to be supplied to the DC/DC converter and the output voltage from the DC/DC converter, a timing for sampling the current flowing through the inductor.

4. A method according to claim 1, wherein detecting the current comprises analog-to-digital-converting the current at the calculated timing.

5. A method according to claim 1, wherein calculating a timing for sampling comprises calculating the timing using an equation given by:
(T÷2)×{1+(output voltage)÷(input voltage)}
by using a switching period T in the PWM control, the detected input voltage, and the detected output voltage.

6. A method according to claim 1, further comprising performing the PWM control by using a value of the detected current, and a value of the detected output voltage.

7. A power supply apparatus comprising:
a first detection unit which detects an input voltage to be supplied to a switching power supply using PWM control;
a second detection unit which detects an output voltage from the switching power supply;
a calculation unit which calculates, based on a ratio between the input voltage detected by the first detection unit and the output voltage detected by the second detection unit, a timing for sampling a current for the PWM control; and
a third detection unit which detects the current based on the calculated timing.

8. An apparatus according to claim 7, wherein the third detection unit detects a current flowing through an inductor in the switching power supply.

9. An apparatus according to claim 7, wherein the third detection unit includes means for analog-to-digital-converting, at the calculated timing, the current flowing through the inductor.

10. An apparatus according to claim 7, wherein the calculation unit calculates the timing using an equation given by:
(T÷2)×{1+(output voltage)÷(input voltage)}
by using a switching period T in the PWM control, the detected input voltage, and the detected output voltage.

11. An apparatus according to claim 7, further comprising a control unit which performs the PWM control by using a value of the detected current, and a value of the detected output voltage.

12. A power supply apparatus comprising:
a DC/DC conversion unit which includes an inductor, and a switching element controlled in accordance with a PWM signal;
a first detection unit which detects an input voltage to be supplied to the DC/DC conversion unit;
a second detection unit which detects an output voltage from the DC/DC conversion unit;
a calculation unit which calculates, based on a ratio between the input voltage detected by the first detection unit and the output voltage detected by the second detection unit, a timing for sampling a current flowing through the inductor;
a third detection unit which detects, at the timing calculated by the calculation unit, the current flowing through the inductor; and
a PWM control unit which controls, by using a value of the current detected by the third detection unit and a value of the output voltage detected by the third detection unit, a pulse width of a PWM signal to be supplied to the switching element.
